(19) United States
(12) Patent Application Publication
(10) Pub. No.: US 2012/0331473 A1
(43) Pub. Date: Dec. 27, 2012

(54) ELECTRONIC DEVICE AND TASK MANAGING METHOD

(75) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/432,169

(22) Filed: Mar. 28, 2012

(30) Foreign Application Priority Data
Jun. 23, 2011 (CN) 201110170610.2

(51) Int. Cl. G06F 9/46

(52) U.S. Cl. 718/103; 718/105

(57) ABSTRACT

A task managing method is configured to manage tasks processed by an electronic device. The electronic device includes a central processing unit (CPU) capable of processing a plurality of the tasks at one time. The task managing method includes the steps of: detecting whether a predetermined status occurs; analyzing a current utilization rate of the CPU; determining whether the current utilization rate is greater than or equal to a predetermined utilization rate; and reducing some tasks being processed by the CPU to keep the CPU working normally, if the current utilization rate is greater than or equal to a predetermined utilization rate.

### BACKGROUND

1. Technical Field

The present disclosure relates to electronic devices, and more particularly to a task managing method.

2. Description of Related Art

Mobile phones are capable of performing a plurality of tasks at any one time. For example, while the mobile phone plays music, the mobile phone also can allow a user to play a game, send a message, and surf the internet. However, if the mobile phone processes too many tasks at the same time, the mobile phone may respond very slowly and may even crash.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an electronic device.

FIG. 2 is a flow chart of a task managing method.

### DETAILED DESCRIPTION

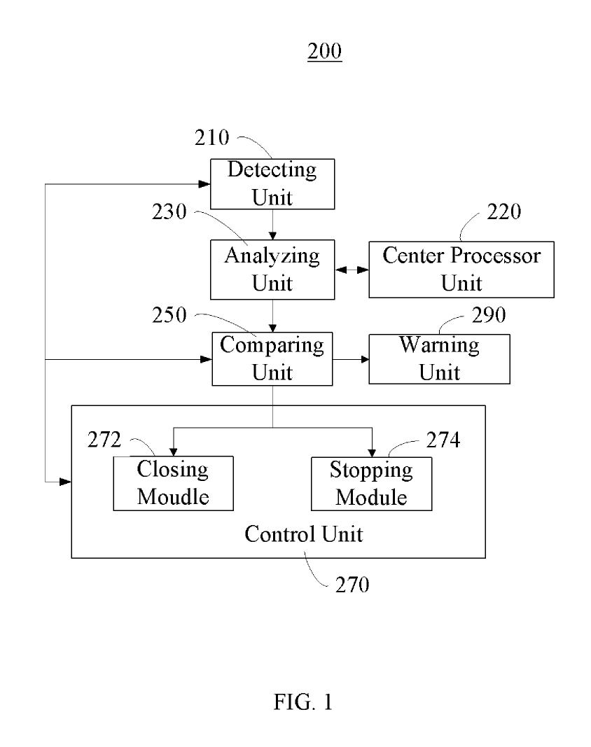

FIG. 1 shows an embodiment of an electronic device 200 having a detecting unit 210, a central processing unit (CPU) 220, an analyzing unit 230, a comparing unit 250, a control unit 270, and a warning unit 290 for providing warning information. The electronic device 200 may be, but not limited to, a mobile phone. The CPU 220 is capable of processing a plurality of tasks at one time.

The detecting unit 210 detects whether a predetermined status exists. The predetermined status exists when a new program is being installed by the CPU 220. The detecting unit 210 further generates a first detecting signal when the predetermined status exists, and generates a second detecting signal when the predetermined status does not exist.

The analyzing unit 230 analyzes a current utilization rate of the CPU 220.

The comparing unit 250 compares the current utilization rate of the CPU 220 with a predetermined utilization rate according to the first detecting signal and second detecting signal. And the comparing unit 250 further generates a comparing signal when the current utilization rate of the CPU 220 is greater than or equal to the predetermined utilization rate. In this embodiment, the predetermined utilization is determined to be 80% when the detecting unit 210 generates the first detecting signal. The predetermined utilization is determined to be 70% when the detecting unit 210 generates the second detecting signal. In another embodiment, the predetermined utilization is determined to be an invariable value, such as 70%.

The control unit 270 reduces the number of tasks being processed by the CPU 220, according to the detecting signals in response to the comparing signal, to maintain normal operations of the CPU 220. So the electronic device 200 will not respond slowly and crash. In this embodiment, the control unit 270 includes a closing module 272 and a stopping unit 274. The closing module 272 closes some tasks being processed by the CPU 220 when the detecting unit 210 generates a first detecting signal, at this time, the warning unit 290 provides warning information to make the user aware of the tasks to be closed. In this embodiment, a priority order of the tasks is predetermined in the CPU 220. The closing module 272 closes the tasks being processed according to the priority order of the tasks, for example, the task being processed, with a lowest priority is closed first. The stopping module 274 prevents the CPU 220 from installing the new program, when the detecting unit 210 generates a second detecting signal, and at this time, the warning unit 290 provides warning information to make the user aware of the stoppage of the installation.

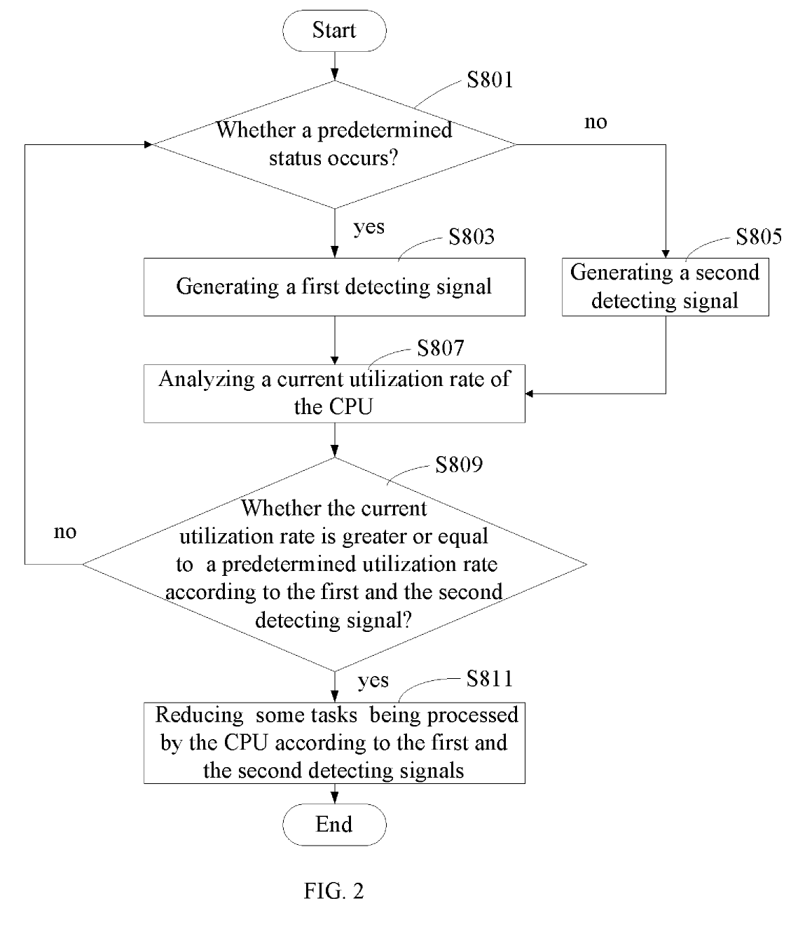

Referring to FIG. 2, a task managing method is applied to control tasks processed by an electronic device to maintain normal operations of electronic device. The electronic device includes a CPU capable of processing a number of tasks at one time. The electronic device may be, but not limited to a mobile phone. The task managing method includes the following steps.

In step S801, detecting whether a predetermined status occurs. For example, the predetermined status occurs when a new program is being installed by the CPU.

In step 803, generating a first detecting signal when the predetermined status occurs.

In step 805, generating a second detecting signal when the predetermined status does not occur.

In step S807, analyzing a current utilization rate of the CPU.

In step S809, determining whether the current utilization rate is greater than or equal to a predetermined utilization rate according to the first detecting signal and the second detecting signal. If the current utilization rate is greater than or equal to the predetermined utilization rate, the processer goes to step S811. If the current utilization rate is lower than the predetermined utilization rate, the processer goes to step S801. In this embodiment, the predetermined utilization is determined based on the first detecting signal and the second detecting signal. For example, the predetermined utilization is determined to be 80% when the first detecting signal is generated. The predetermined utilization is determined to be 70% when the second detecting signal is generated. In another embodiment, the predetermined utilization is determined to an invariable value, such as 70%.

In step S811, reducing some tasks being processed by the CPU according to the first and the second detecting signals, when the current utilization rate is greater than or equal to a predetermined utilization rate, so the electronic device can maintain normal operations, and will not respond slowly and crash. In this embodiment, some tasks being processed by the CPU are closed when a first detecting signal is generated. In this embodiment, a priority order of the tasks is predetermined in the CPU 220. The tasks being processed are closed according to the priority order of the tasks. For example, the task with a lowest priority is closed first. The new program is prevented from installing the new program when a second detecting signal is generated.

It is to be understood, however, that even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device comprising:
a central processing unit (CPU) to process a plurality of tasks at one time;
an analyzing unit to analyze a current utilization rate of the CPU;
a comparing unit to compare the current utilization rate with a predetermined utilization rate, and generating a comparing signal when the current utilization rate is greater than or equal to the predetermined utilization; and
a control unit to reduce some tasks being processed by the CPU in response to the comparing signal.

2. The electronic device of claim 1, further comprising a detecting unit to detect whether a predetermined status exists in the electronic device, and generate a first detecting signal when the predetermined status exists.

3. The electronic device of claim 2, wherein the detecting unit generates the first detecting signal when a new program is being installed by the CPU, the control unit closes some tasks being processed by the CPU in response to the comparing signal when the first detecting signal is generated.

4. The electronic device of claim 3, wherein a priority order of the tasks processed by the CPU is predetermined, and the control unit closes some tasks being processed with low priority.

5. The electronic device of claim 4, further comprising a warning unit to provide information to make users aware of the tasks to be closed.

6. The electronic device of claim 2, wherein the detecting unit generates a second detecting signal when the predetermined status does not exist.

7. The electronic device of claim 6, wherein the second detecting unit generates the second detecting signal when a new program is not being installed by the CPU.

8. The electronic device of claim 7, further comprising a warning unit to provide information to make users aware of the installation being stopped.

9. A task managing method for managing tasks processed by an electronic device, the electronic device comprising a central processing unit (CPU) capable of processing a plurality of the tasks at one time, the task managing method comprises the steps of:
analyzing a current utilization rate of the CPU;
determining whether the current utilization rate is greater than or equal to a predetermined utilization rate; and
reducing some tasks being processed by the CPU to keep the CPU working normally, if the current utilization rate is greater than or equal to a predetermined utilization rate.

10. The task managing method of claim 9, further comprising the following steps before the step of determining whether the current utilization rate is greater than or equal to the predetermined utilization rate:
detecting whether a predetermined status occurs; and
generating a first detecting signal when the predetermined status occurs.

11. The task managing method of claim 10, wherein generating a second detecting signal when the predetermined status does not occur.

12. The task managing method of claim 11, wherein the predetermined status occurs when a new program is being installed.

13. The task managing method of claim 12, wherein the step of reducing some tasks being processed by the CPU is performed by stopping installing the new program according to the second detecting signal.

14. The task managing method of claim 10, wherein the step of reducing some tasks being processed by the CPU is performed by closing some tasks being processed by the CPU according to the first detecting signal.

14. The task managing method of claim 13, wherein a priority order of the tasks processed by the CPU is predetermined, and the task being processed with a lowest priority is closed first.

15. The task managing method of claim 12, wherein the
returning to the step of detecting whether a predetermined status occurs, if the current utilization rate is lower than the predetermined utilization rate.
